(19) United States
(12) Patent Application Publication
(10) Pub. No.: US 2017/0153796 A1
(43) Pub. Date: Jun. 1, 2017

(54) USER INTERFACE FOR POINT OF SALE DEVICE

(71) Applicant: INTALE INC, WILMINGTON, DE (US)

(72) Inventors: KONSTANTINOS KAZANIS, Athens (GR); ORESTIS-EVANGELOS TZANETIS, Athens (GR); FOTIOS KOUTOUVELIS, Athens (GR)

(73) Assignee: INTALE INC, WILMINGTON, DE (US)

(21) Appl. No.: 14/955,286

(22) Filed: Dec. 1, 2015

(51) Int. Cl. G06F 3/0484; G06F 3/0488; G06F 3/0482; G06Q 20/20

(52) U.S. Cl. CPC G06F 3/04845; G06Q 20/20; G06F 3/04842; G06F 3/04883; G06F 3/04886; G06F 3/0482

(57) ABSTRACT

Devices and techniques are disclosed for identifying user selection actions on a POS device and based on the action changing the default color of a numpad to a different default color associated with the quick key for that action, while at the same time changing the default number, key, and symbol arrangements on the numpad to the default number, key and symbol arrangements of the quick key action. In another aspect, the quick key actions include at least one of a cash value discount selection key and a percent cash value selection key. At least one quick key action is triggered by a retailer/user performing a tactile gesture which in turn causes a trigger action to be displayed on the user interface screen in a particular color which color matches the numpad color, and which numpad color is different from the default numpad color.

### TECHNICAL FIELD

The present disclosure relates to point of sale devices and, in particular, techniques for making point of sale devices more user-friendly.

### BACKGROUND

The point of sale (POS) is the time and place where a retail transaction is completed. It is the point at which a customer makes a payment to the merchant in exchange for goods or after provision of a service. At the point of sale, the merchant would prepare an invoice for the customer (which may be a cash register printout) or otherwise calculate the amount owed by the customer and provide options for the customer to make payment. After receiving payment, the merchant will also normally issue a receipt for the transaction. Usually the receipt is printed, but it is increasingly being dispensed electronically.

The POS in various retail situations would use customized hardware and software tailored to their particular requirements. Retailers may utilize weighing scales, scanners, electronic and manual cash registers, EFTPOS terminals, touch screens and a variety of other hardware and software available. For example, a grocery or candy store may use a scale at the point of sale, while a bar and restaurant may use software to customize the item or service sold when a customer has a meal or drink request.

The point of sale is often referred to as the point of service because it is not just a point of sale but also a point of return or point of customer order. Today POS software may include additional features to cater for different functionality, such as inventory management, CRM, financials, warehousing, and much more.

It is very important that data entered at the POS is entered accurately. Unfortunately, the more POS software functionality that a device can support, the greater the chance for errors due to date entry. To avoid errors, extra time and/or resources may need to be utilized.

It would be desirable to be able to improve the user interface of POS devices to address the above problems.

### SUMMARY

The proposed disclosure describes devices and techniques for identifying user selection actions on a POS device and based on the action changing the default color of a numpad to a different default color associated with the quick key for that action, while at the same time changing the default number, key, and symbol arrangements on the numpad to the default number, key and symbol arrangements of the quick key action.

In another aspect, the quick key actions include at least one of a cash value discount selection key and a percent cash value selection key.

In yet a further aspect, at least one quick key action is triggered by performing a tactile gesture which in turn causes a trigger action to be displayed on the user interface screen in a particular color which color matches the numpad color and which numpad color is different from the default numpad color.

In yet a further aspect, there is further provided a quick key for identifying the product or service to be charged to the customer. When the quick key is triggered at checkout, the default indicators for that item includes a default number of purchase items, a price per purchase item, and the total cost of displayed default items. There is provided the ability to identify a quick key action (e.g., a screen tap or specific tactile gesture) to cause various functions to be enabled, including a function for manually changing the amount of purchase items, while at the same time changing the color, number, key and symbol arrangements on the numpad to match the default color of the quick key action, as well as the number, key and symbol arrangements associated with the same quick key action.

In another aspect, the quick key actions may include selection features directly on the icon associated therewith to allow the user the further option to change values associated with a given function or feature directly from the icon.

### BRIEF DESCRIPTION OF THE DRAWINGS

FIG. 1 is a high level schematic block diagram illustrating exemplary POS processing in accordance with various aspects of the present invention.

FIGS. 2-18 are exemplary screenshots of a POS device touch screen showing POS user interface features and functionalities in accordance with the present invention.

FIG. 19 is a high level operational flow diagram in accordance with an exemplary embodiment.

### DETAILED DESCRIPTION

The following disclosure presents and describes various exemplary embodiments in sufficient detail to enable those skilled in the art to practice the invention, and it should be understood that other embodiments may be realized without departing from the spirit and scope of the invention. Thus, the following detailed description is presented for purposes of illustration only, and not of limitation, and the scope of the invention is defined solely by the appended claims.

The present invention may be described herein in terms of functional block components and various processing steps. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as C, C++, Java, COBOL, assembler, PERL, or the like, with the various algorithms being implemented with any combination of data structures, objects, processes, routines, or other programming elements. Further, it should be noted that the present invention may employ any number of conventional techniques for data transmission, signaling, data processing, network control, and the like.

It should be appreciated that the particular implementations shown and described herein are illustrative of the invention and its best mode and are not intended to otherwise limit the scope of the present invention in any way. Furthermore, the connecting lines shown in the various figures contained herein are intended to represent exemplary functional relationships and/or physical couplings between the various elements. It should be noted that many alternative or additional functional relationships or physical connections may be present in a practical incentive system implemented in accordance with the invention.

Communication between participants in the system of the present invention is accomplished through any suitable communication means, such as, for example, a telephone network, public switch telephone network, intranet, Internet, extranet, WAN, LAN, point of interaction device (e.g., point of sale device, personal digital assistant, cellular phone, kiosk terminal, automated teller machine (ATM), etc.), online communications, off-line communications, wireless communications, satellite communications, and/or the like. One skilled in the art will also appreciate that, for security reasons, any databases, systems, or components of the present invention may consist of any combination of databases or components at a single location or at multiple locations, wherein each database or system includes any of various suitable security features, such as firewalls, access codes, encryption, de-encryption, compression, decompression, and/or the like.

It further will be appreciated that users may interact with the system via any input type POS device with any suitable touch screen computing device, including tablets, and special purpose POS devices equipped with touch screens.

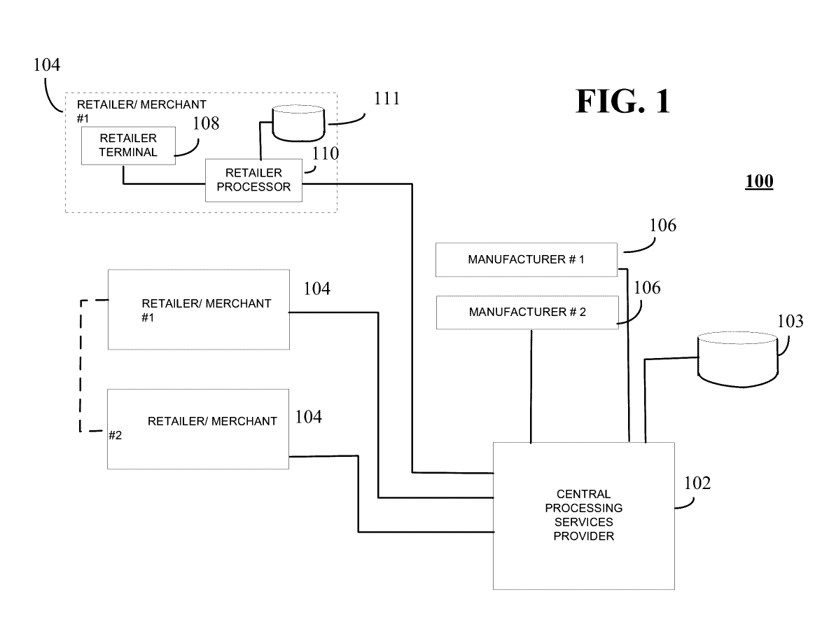

In accordance with the present invention, FIG. 1 is a high level schematic block diagram illustrating an exemplary POS processing system 100.

System 100 comprises a central processing services provider 102; a plurality of retailer/merchant systems 104; and at least one supplier/manufacturer 106. One skilled in the art will appreciate that system 100 may comprise any number of retailer systems 104 and any number of suppliers/manufacturers 106.

The central processing services provider 102 manages the activities of the system 100. In an exemplary embodiment, central processing services provider 102 receives, processes, and stores manufacturer data, such as information regarding products and/or services and UPC data, transmitted by manufacturers 106 who have enrolled in the system 100. Manufacturers 106 may transmit data to processing services provider 102 in any form and by any means known in the art, including any of the communications means described above. The manufacturer data is stored by the central processing services provider 102 in database 103. Database 103 may be any type of database, such as relational, hierarchical, object-oriented, and/or the like.

The central processing services provider 102 may receive and process consumer ID information and purchase data from any of the retailer systems 104.

In an exemplary embodiment, retailer system 104 comprises a retailer terminal 108 and a retailer processor 110 in communication with database 111. Retailer terminal 108 serves as a POS device and is equipped with a colored touch screen.

Each retailer POS terminal device 106 are interconnected to suppliers/manufacturers 106 typically via central processing services provider 102 (as shown), but may also be connected directly to one or more suppliers/manufacturers (not shown).

Aspects of the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

In accordance with an exemplary embodiment of the present invention, an improved user interface and user interface experience is set out. The invention is implemented by POS processing system 100 in response to the system identifying user selection actions on a POS device. Based on the action identified, the POS device is configured to change the default color of a numpad to a different default color associated with the quick key for that action, while at the same time changing the default number, key, and symbol arrangements on the numpad to the default number, key and symbol arrangements of the quick key action.

In another aspect, the quick key actions include at least one of a cash value discount selection key and a percent cash value selection key.

In yet a further aspect, at least one quick key action is triggered by performing a tactile gesture which in turn causes a trigger action to be displayed on the user interface screen in a particular color which color matches the numpad color, which numpad color is different from the default numpad color.

In yet a further aspect, there is further provided a quick key for identifying the product or service to be charged to the customer. When the quick key is triggered at checkout, the default indicators for that item includes a default number of purchase items, a price per purchase item, and the total cost of displayed default items. There is provided the ability to identify a quick key action (e.g., a screen tap or specific tactile gesture) to cause various functions to be enabled, including a function for manually changing the amount of purchase items, while at the same time changing the color, number, key and symbol arrangements on the numpad to match the default color of the quick key action, as well as the number, key and symbol arrangements associated with the same quick key action.

In another aspect, the quick key actions may include selection features directly on the icon associated therewith to allow the user the further option to change values associated with a given function or feature directly from the icon.

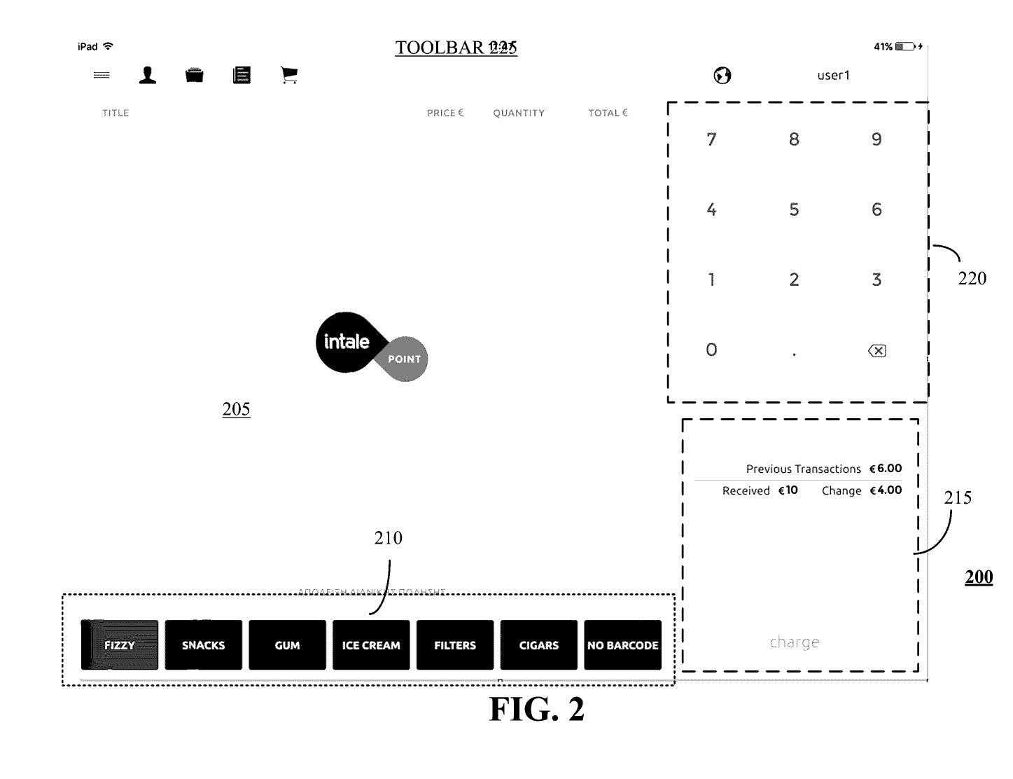

These and other features and aspects of the present invention will now be described below with reference to the various screen shots depicted in FIGS. 2-18.

FIG. 2 shows an exemplary touch screen interface of a POS terminal device in accordance with an exemplary embodiment. The unique aspect to be described concerns the manner whereby selections by a user—normally the retailer in this case, as opposed to the purchasing customer—trigger software in the POS terminal device to respond by adopting or changing UI function and color attributes. The change in function and color attributes are aimed at preventing data error entry, speeding up data entry, and also making data entry easier and more user friendly in general.

Referring to FIG. 2, we see a screenshot 200 of a default start up screen. For purposes of description, the screen is comprised of four key sections: (i) a product basket section 205; (ii) a quick key display section 210; (iii) a costs total section 215; and (iv) a numpad section 220. A toolbar section 225 may also be provided to allow for additional functions and capabilities of the POS which are beyond the scope of the present invention, and all of which are well known and understood by those familiar with POS device technology.

Each section is uniquely colored, in whole or in part with certain default settings. For example, the default color for numpad section 220 is the color white. The color white is represented as COLOR NUM DEF. Similarly, quick key section 210 items (of which three are shown each corresponding to a specific product list of items sold in a restaurant in this case) are depicted in red. The color red is represented as COLOR PL DEF. The product basket section 205 and the costs total section 215 are both of color COLOR PB DEF and COLOR TC DEF, respectively.

The various uses and operation of each of the above sections will become more apparent as we navigate through the provided figures.

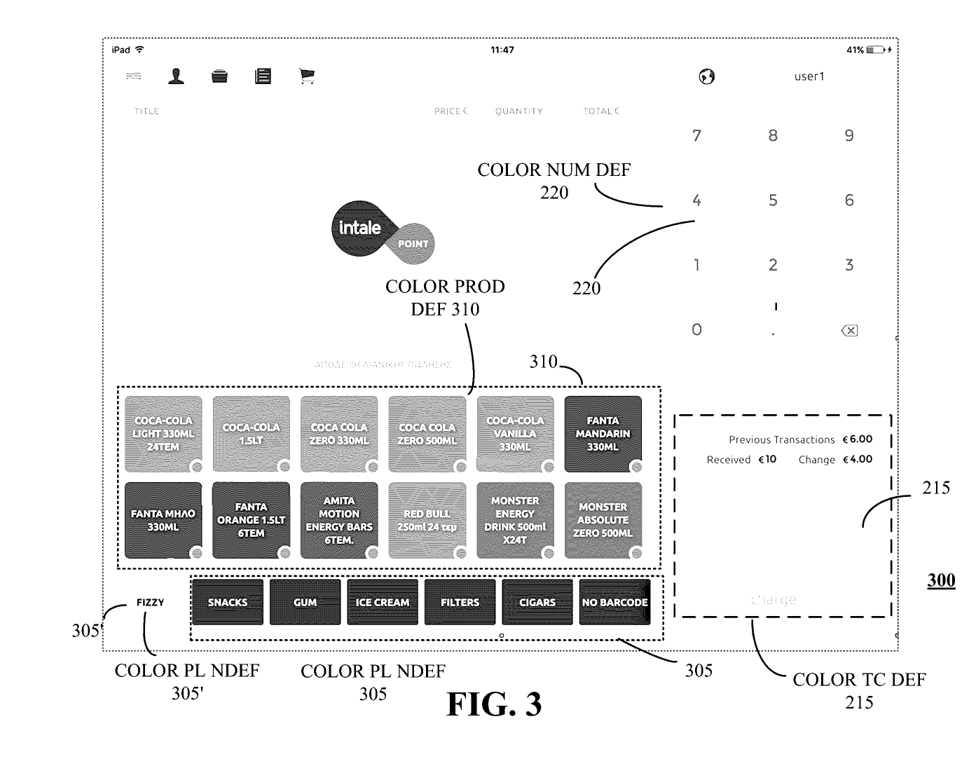

FIG. 3 is an updated screenshot 300 showing what happens as a user makes menu selections in order to place in the basket different products from the various available product lists.

The first step is to select a product list from the three product lists 305 shown. The figure shows that the user has in fact selected a product list (305′) which has resulted in icon 305′ changing to a color other than the default color (i.e., from COLOR PL DEF to COLOR PF NDEF. At the same time as that selection and color change was made, new quick keys 310 were created and displayed automatically. These new keys might originally share one color, be coupled into color groups, or can all be different colors. For discussion purposes, the original color of quick keys 310 is represented as COLOR PROD DEF. Thus, the user is instantly made aware of the key selections that were made and whether or not new keys were derived from these key selections.

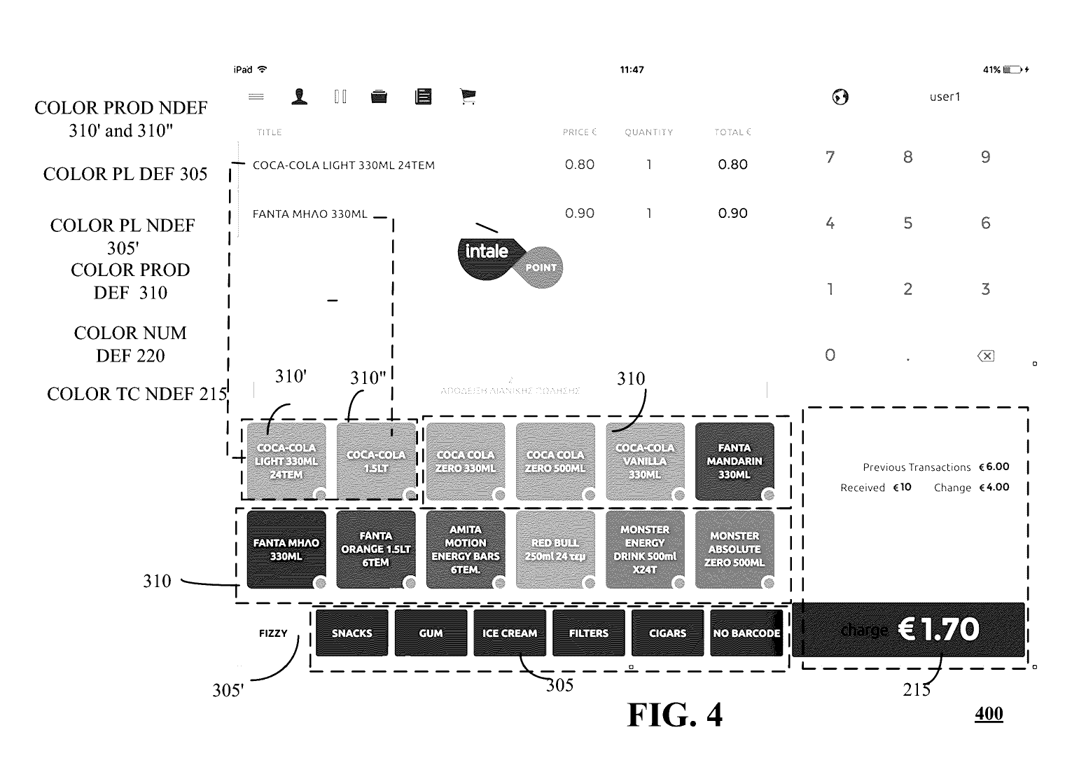

Moving on to FIG. 4, here we see a screenshot 400 showing the user having selected two products 310′ and 310″ from products list 305′. As this occurred, the color of these two products was changed from COLOR PROD DEF to a COLOR PROD NDEF. The point here is to communicate to the user which products correspond to which keys so the user can de-activate the appropriate quick key when either the customer change his mind about an order or when the user accidentally presses a wrong quick key and needs to deselect. Because pressing the same quick key repeatedly selects and deselects products, the interface must provide a different way to place an order for different items. This different way is discussed below.

At this step of FIG. 4, numpad section 220 went from inactive to idle mode where it is set up and waiting to be fed entries regarding the payment to be made by customer.

The costs total section 215 has also gone from inactive to active. To communicate this to the user, costs total section 215 is changed from COLOR CT DEF to COLOR CT NDEF. At same time, we see that the system automatically calculated the total cost balance for the two quick key items 310′ and 310″ and displayed the total cost of the order (7.70 euro) in the bottom section 405 of costs total section 215.

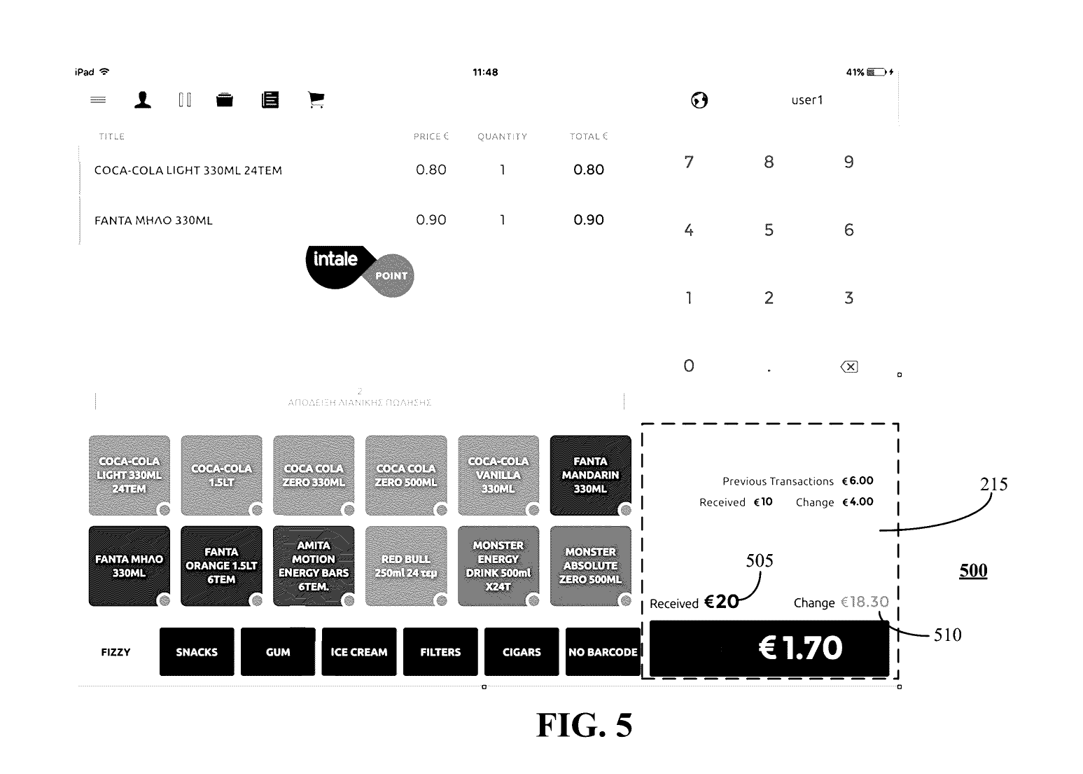

In FIG. 5, we see a screenshot 500 showing the user having entered that he received 20 euro. The system automatically records and displays the payment amount as well as the change due at positions 505 and 510, respectively, of costs total section 215.

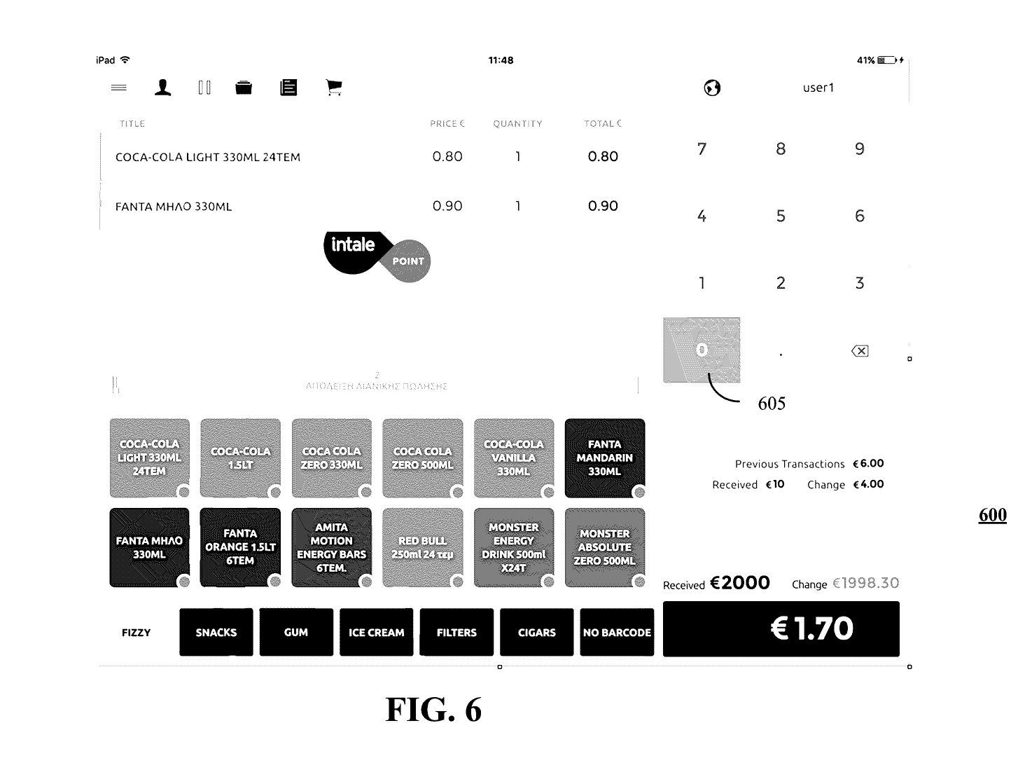

In FIG. 6, we see yet a further screenshot 600 showing the user attempting to enter an improper amount. The numpad section responds appropriately in this case. In the example shown further attempts to tap an improper key selection results in the corresponding key 605 lighting up/changing color. A message (not shown) may also be used to provide proper additional notice.

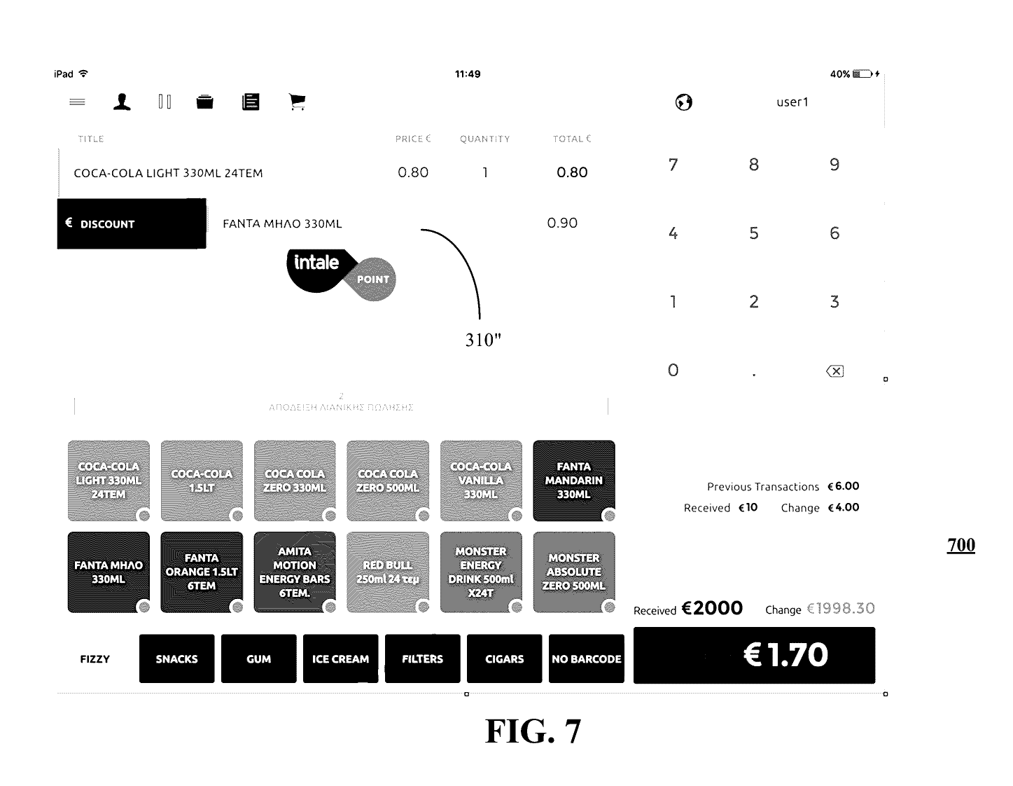

FIG. 7 is a screenshot 700 depicting what happens when the user taps or makes any similar tactile gesture from within the product basket section 205. In a first example scenario, the sliding of the finger in the right direction is intended to cause the selected product description to go into product cash amount discount mode.

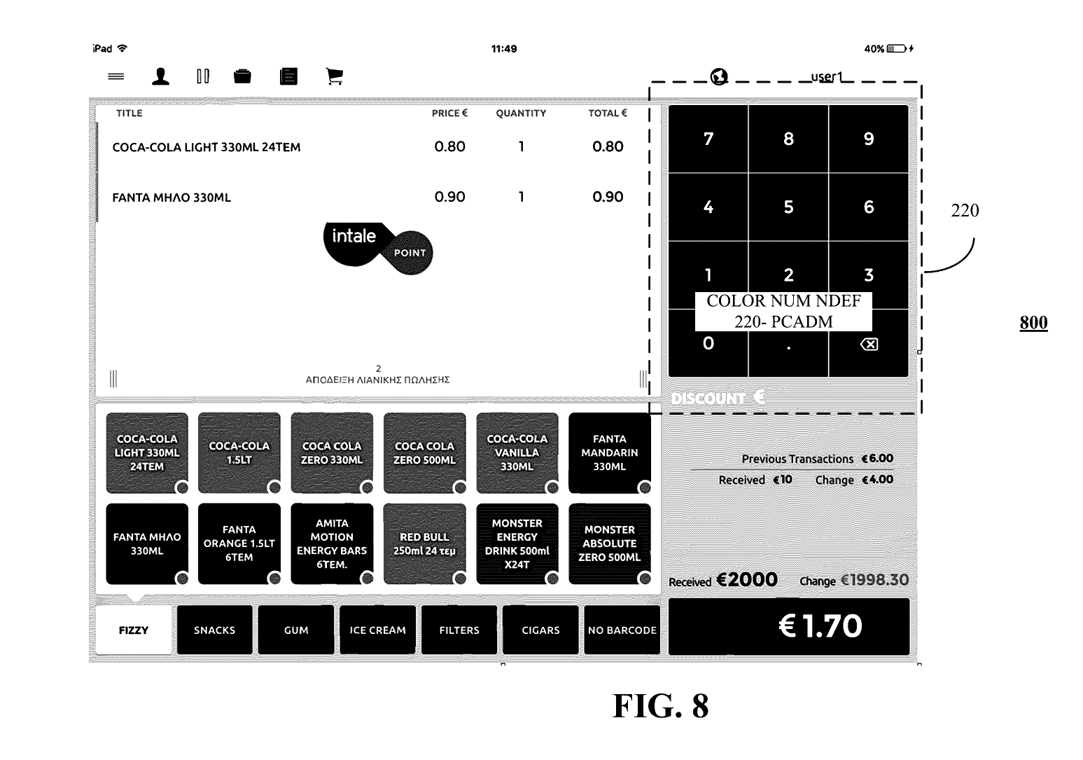

In screenshot 800 of FIG. 8, we see that when this happens an appropriate color indicator appears in or near the selected product to be discounted, and at the same time, the numpad section color changes to match the color associated with the color of product cash amount discount mode. Ordinarily, the numpad configuration would change to remove or add numbers or symbols that are not relevant to that mode, however, in the current example, only the numpad section color changes (to COLOR NUM NDEF-PCADM) on account that the numpad keys remain the same when transitioning from/to this mode.

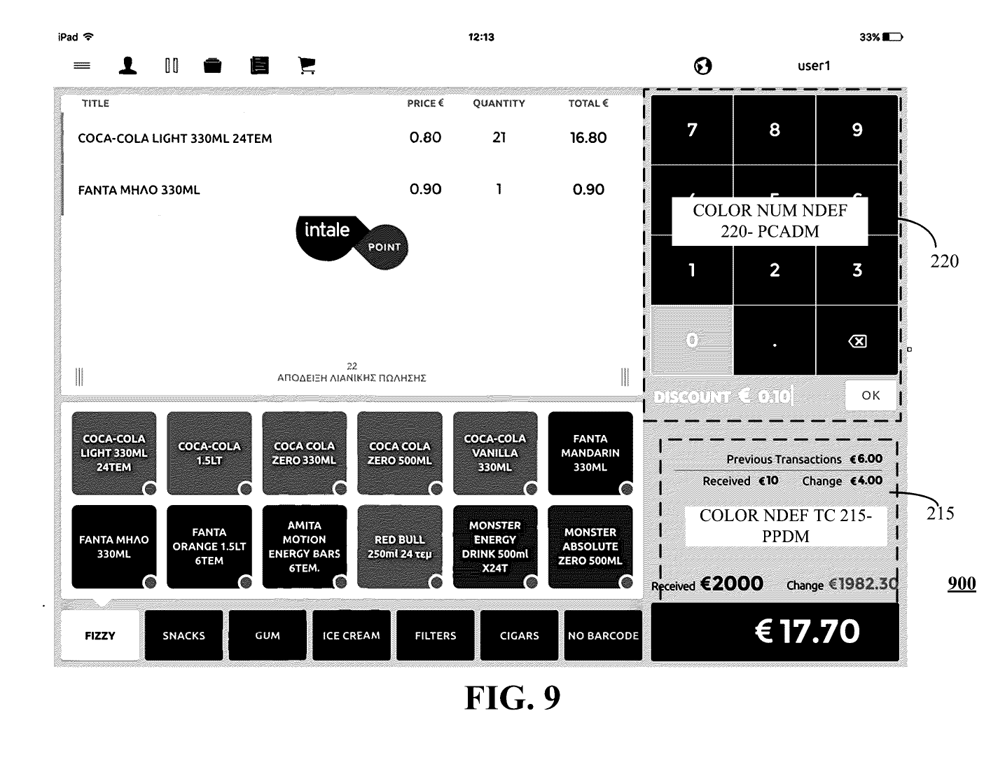

FIG. 9 is a screenshot 900 showing the user typing a cash amount (0.10 euro) to be awarded the customer.

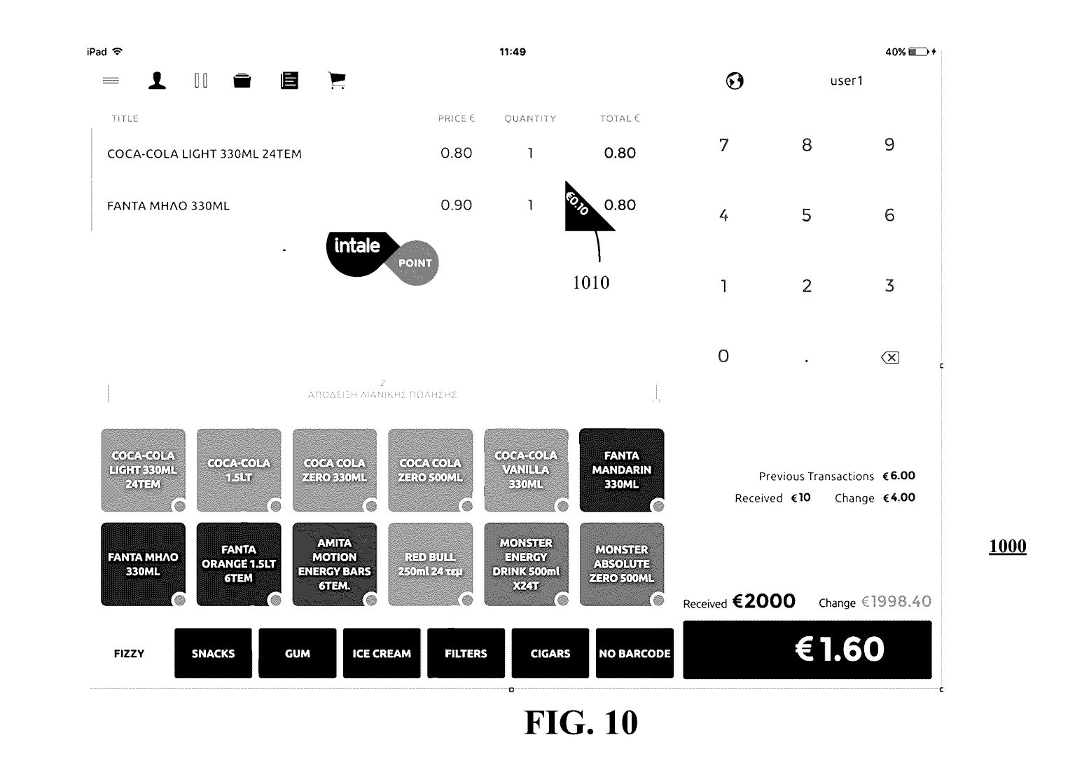

In the screenshot 1000 of FIG. 10 we can see that the cash discount has been applied bringing the new total to 1.60 versus 1.70 which is old total amount.

Once the cash account discount has been applied, we see that an indicator 1010 is added to the product basket definition for the discounted product to easily and quickly alert the user of his having made the discount in case he desires to change it, remove it, or delete it.

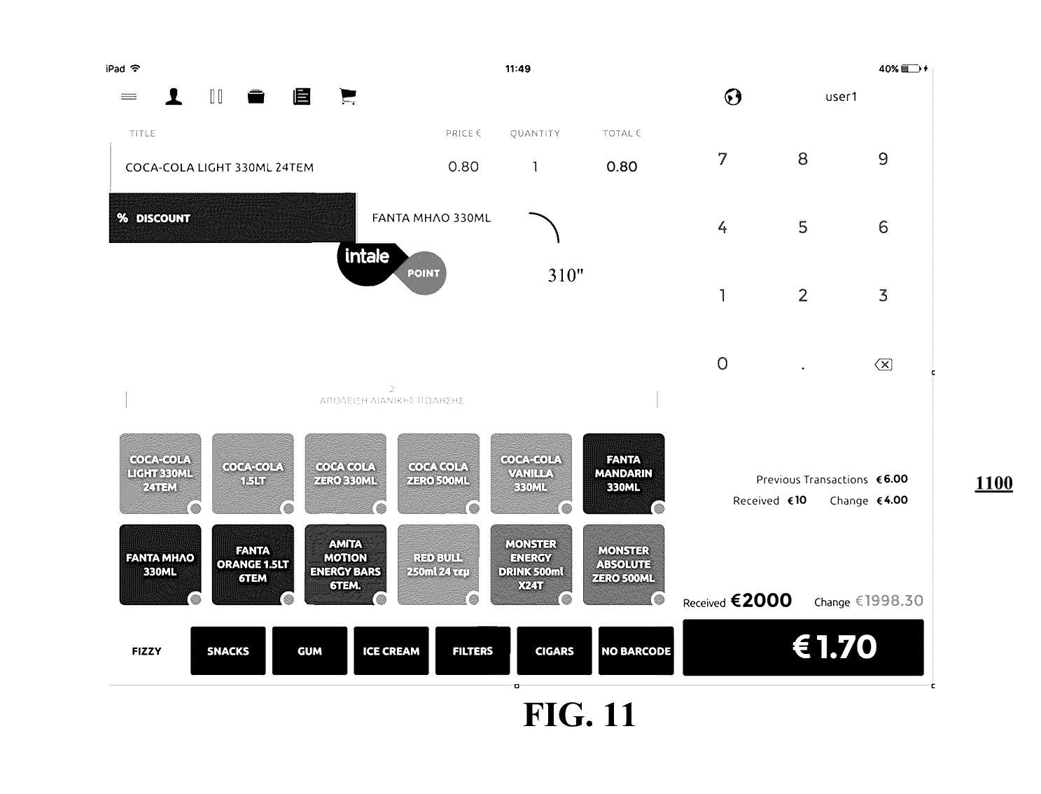

Referring to screenshot 1100 of FIG. 11, here we see the user desiring to apply a percentage discount instead of a fixed price discount to item 310″.

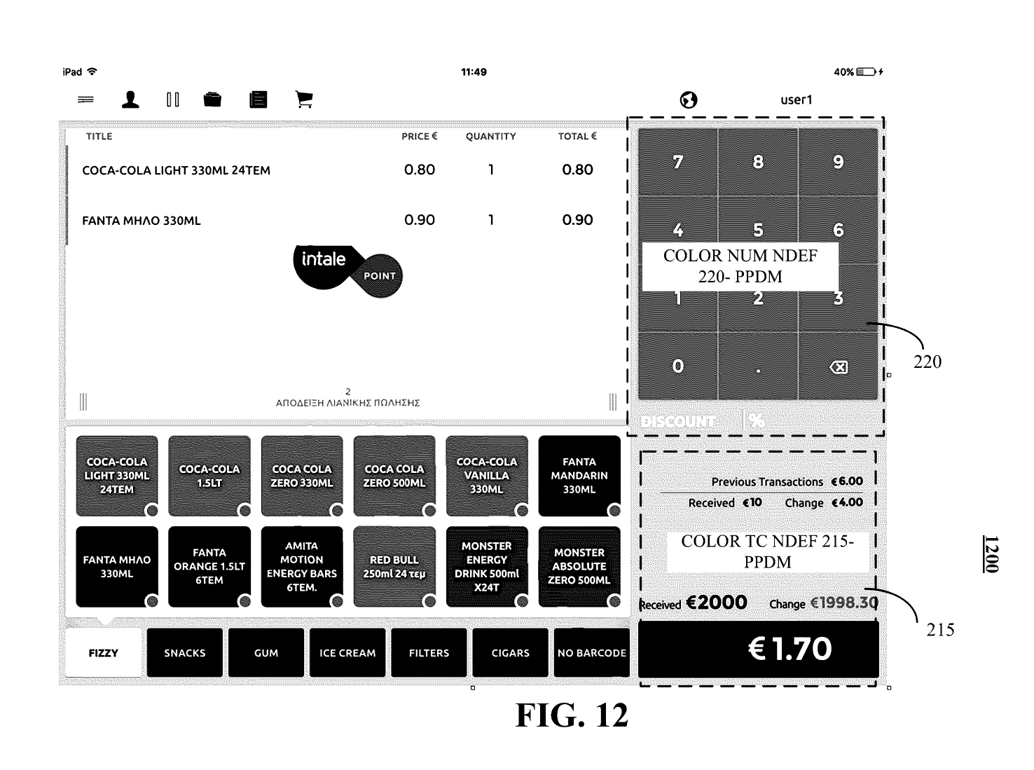

Here again, the attempt is made by making the appropriate tactile gesture on the screen calling the device to trigger the product percentage of price discount mode. This mode also has a particular unique color attribute scheme shown in FIG. 12. Specifically, both numpad section 220 and costs total section 215 change to colors COLOR NUM NDEF-PPDM and COLOR TC NDEF-PPCM, to indicate to the user that it has entered price percentage discounmt mode visually and from there to wait for user to enter a percent discount number to be applied to price.

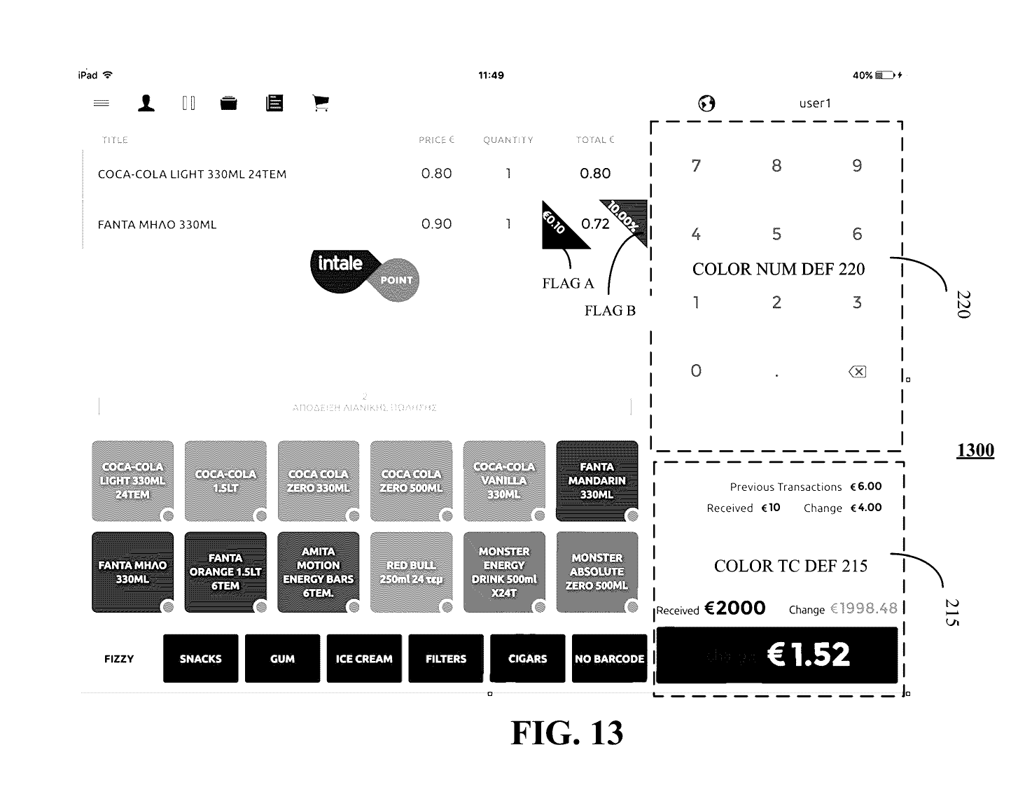

FIG. 13 is a screenshot 1300 of the device having exited product percentage of price discount mode. A visual cue for this is that the color of numpad section 220 and costs total section 215 are returned to their original default colors. (COLOR NUM DEF and COLOR TC DEF). When a price cash amount discount and a product percentage discount have BOTH been applied, instead of 1 flag, there will be two flags (FLAG A, FLAG B)provided somewhere on or near the item discounted (in this case item 310″) to show this. In an exemplary embodiment, the amount of the respective discount appears on the flag. haveis once again modified to correspond to the default colors the color assigned to the quick key function related to product percentage of price discount mode. For discussion purposes, the color of numpad 220 is shown changed to COLOR NUM NDEF-PPDM.

It is also possible to see that the amount owed shown in costs total section 215 has been reduced down from 7.50 to 7.33 (a 2% change in value) on account of discount applied by user making a manual percentage indication data entry.

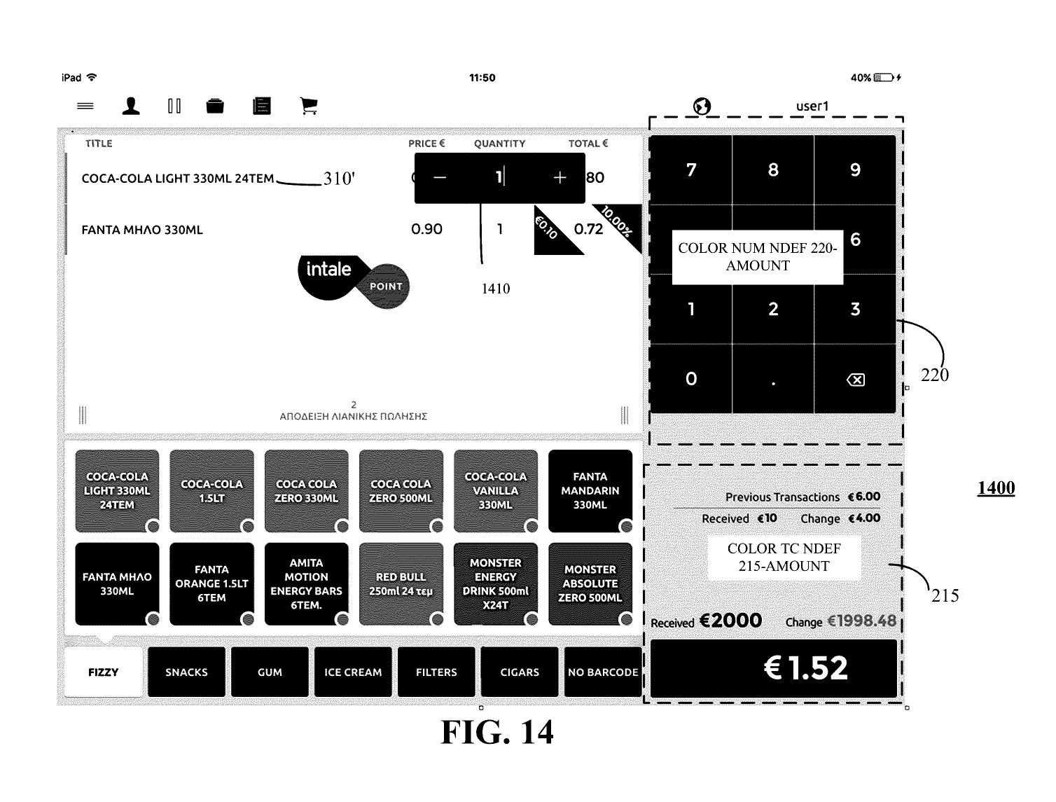

Moving to FIG. 14, this is a further screenshot 1400 showing the user having tapped on the amount field indicated in connection with product 310′ price. Here, a pop up menu 1410 is generated with color COLOR NUM NDEF AMOUNT, which simultaneously causes numpad section 220 to change to the identical color. The costs total section may also change accordingly.

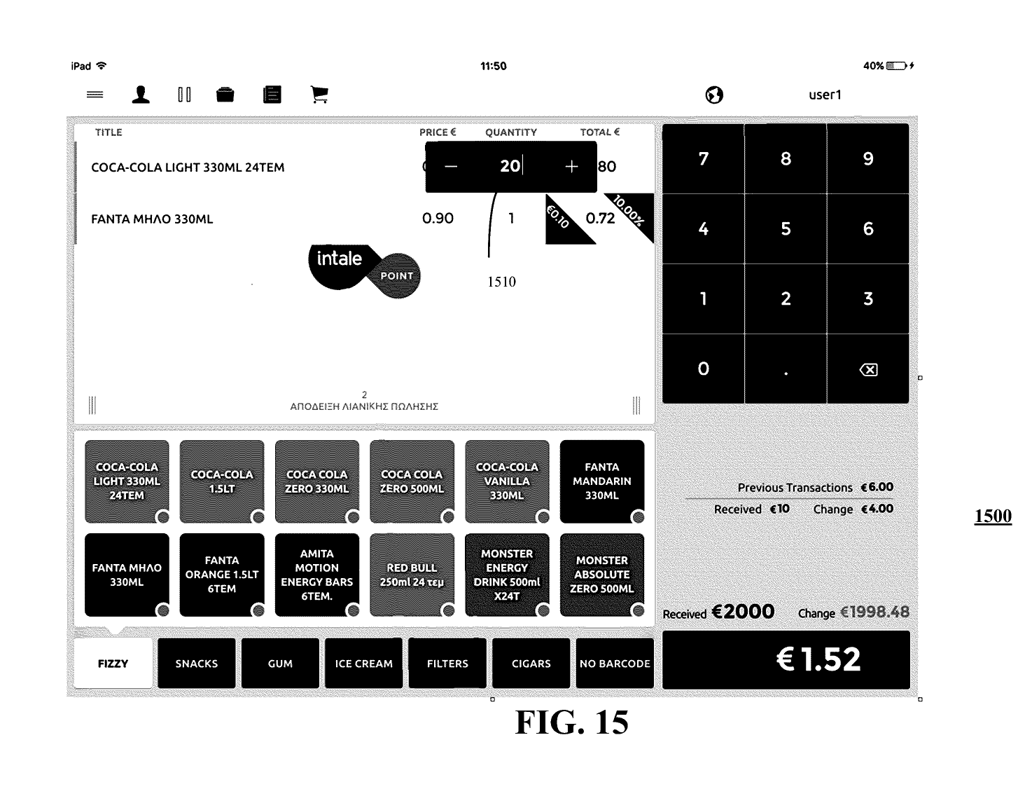

In FIG. 15 (screenshot 1500), the user is entering using numpad section 220 a new amount of each product to be purchased. The amount is automatically updated in pop up menu 1410 to show the new amount typed (box 1510).

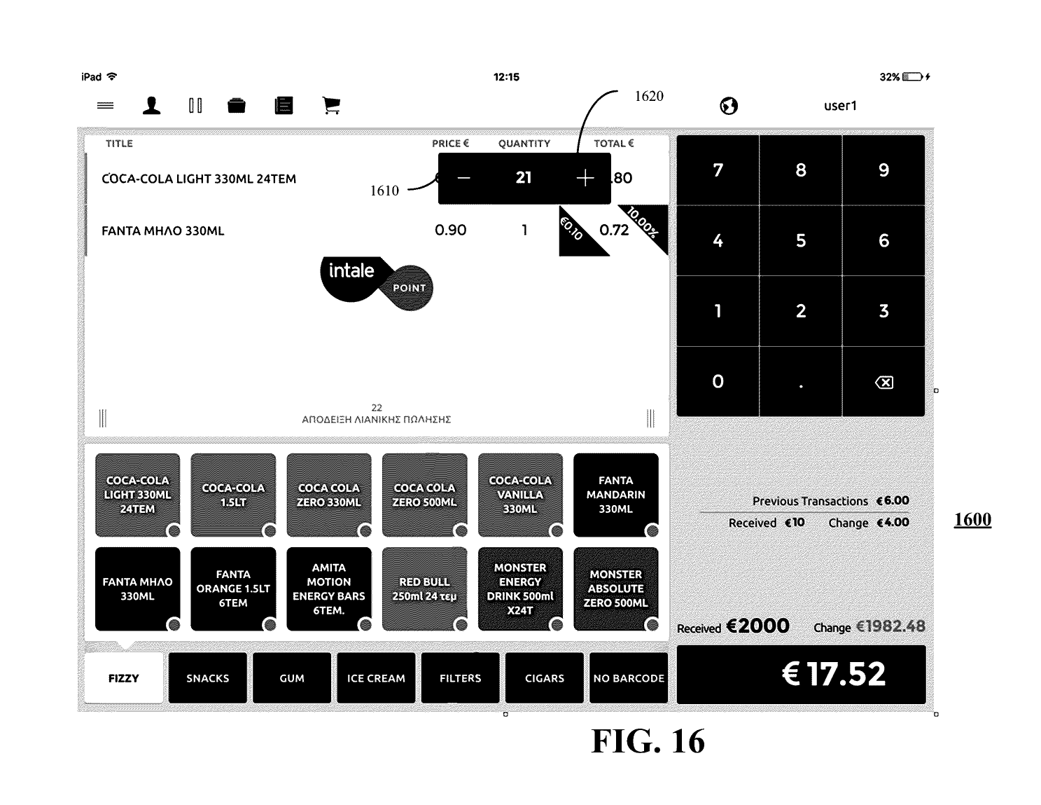

In FIG. 16, (screenshot 1600), we see the user further modify the previous amount entered by using selection down/up indicators 1610, 1620 incorporated in pop up menu 1410. Here, the amount of items is shown increased by one to 21 from 20 using the UP indicator. The price shown in the costs total section is updated automatically.

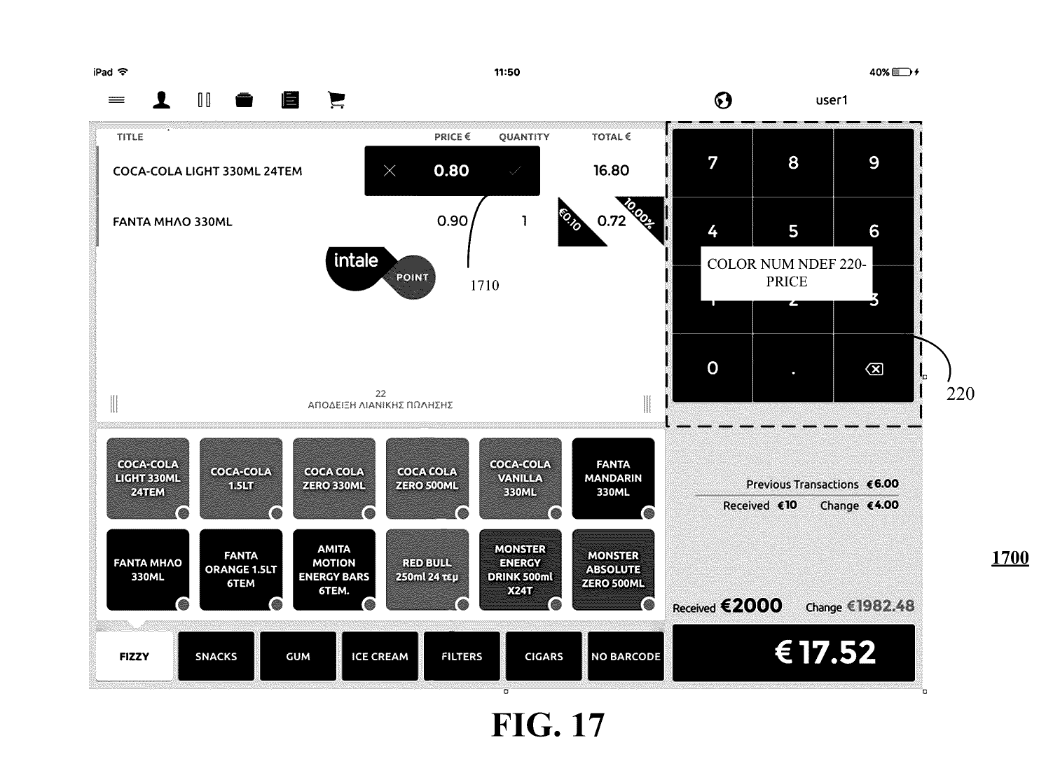

In FIG. 17 (screenshot 1700), the user invokes yet a further mode, which is the price setting mode. Here, a further pop up menu 1710 is generated with color COLOR NUM NDEF PRICE, which simultaneously causes numpad section 220 to change to the identical color. This mode allows the user to change the actual price point of a product as opposed to provide a discount on a per item basis.

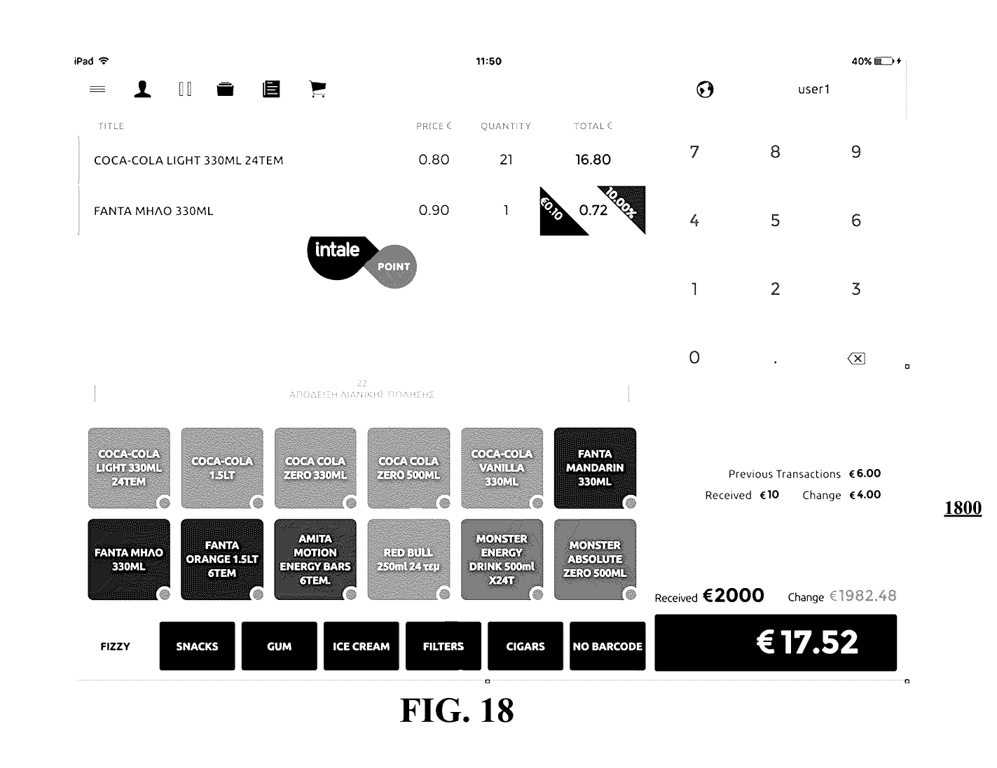

Having set the amount and price on a given product, the user hits enter key and the product descriptions are cumulatively updated and the new account balance (new amount owed) is generated. The re-calculated totals, price and amount per product is illustrated in screenshot 1800 of FIG. 18. From here we can see that the device goes back to color COLOR NUM DEF mode and waits from input for the user. In the meantime, the visuals showing that both price and percent discounts were applied remain in the form of markers on or near the applicable product description.

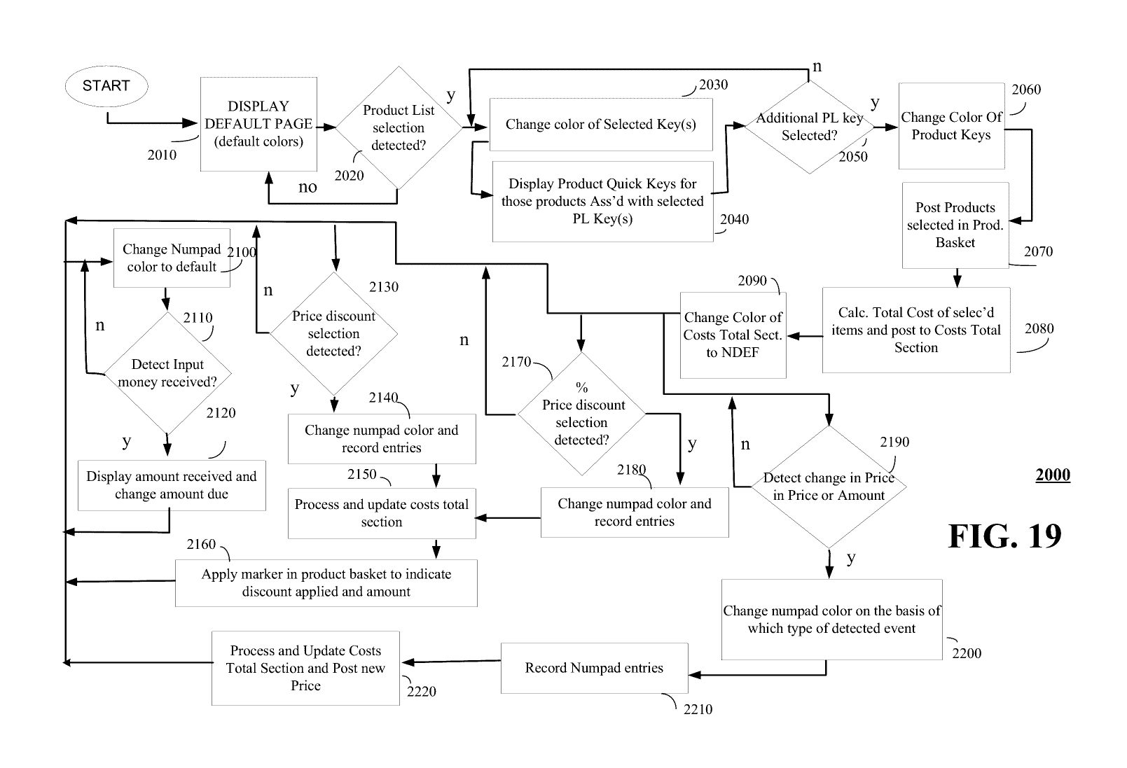

FIG. 19 is a high level operational flow diagram 2000 in accordance with an exemplary embodiment.

Upon powering up the POS terminal device, the device goes into ready mode. Here, a default start page is displayed having the default sections 205, 210, 215, 220 and 225 described earlier in showing in FIG. 2 (step 2010).

Upon detecting (step 2020) that a products list key 305 has been triggered by touch or otherwise, that key (now key 305′) color is changed to a non-default color to provide a visual cue that it is active (step 2030).

Automatically the products (310) that belong to that product list are likewise displayed (step 2040).

Upon detecting (2050) a key press selection for any of the listed product keys, the pressed keys are color modified (i.e., set to a non-default color to provide a further visual cue that these keys (now 310′ and 310″ in our example earlier) are active (step 2060).

Automatically, the products selected are also posted in the basket section 205 of the screen (step 2070).

Also, the total cost of the products selected is calculated and the amount posted to the costs total section 215 of the screen (2080) at the same time that the color of section 215 is changed to a non-default color to indicate that there is an active buy-sell transaction between retailer and customer in play (2090).

Up to this point, none of the selected keys involved numpad section activity. Accordingly, the numpad section remains in default mode with default colors being displayed (2100). If it is not in default mode, it changes to default upon detecting the enter key being pressed in connection with another mode of operation.

When the device detects keypad activity at numpad section 220, it will treat the input as corresponding to an amount of money received from a customer (step 2110). The device calculates the amount still owed (or amount overpaid) and displays the amount paid and owed (or overpaid) in the costs total section 215 (step 2120).

In lieu of processing payment, user may desire to first credit the customer with a price discount (2130, 2170). To initiate this, the user selects between available possible price discounts. We have discussed by way of example above an actual cash price discount and a percentage of price type discount. Both discounts have a unique color marker. This color marker indicates both the specific product item that was discounted and the type of discount, as well as serves to inform the user what mode the system is in when the numpad section color is the color of the specific price discount (2140, 2180).

The color modified numpad calculates the discount using the appropriate formula depending in what discount mode the device is in, and reprints the balance owed amount in the costs total section to reflect the discount (2150). Once the enter key is struck by the user, this informs the software that the mode is exited and for the device to return to a previous default mode (2100). In parallel, a product specific color marker is placed on or near the discounted product listed in the product basket (2160).

Finally, the software is configured to detect changes in price or amount of items desired on a product by product basis by detecting corresponding selection presses on or near the vicinity of the given product (2190).

As previously explained, once again, the numpad section changes color to reflect the mode that's been entered (e.g., price adjust mode versus amount adjust mode). As price or amounts are changed, the device calculates and displays the new totals in the product basket 205 on a product by product basis, and also updates the costs total section 215 to show the new total amount due by customer (2210, 2220, 2230).

The present invention has been described with reference to block diagrams and flowchart illustrations of methods, apparatus (e.g., systems), and computer program products according to various aspects of the invention. It will be understood that each functional block of the block diagrams and the flowchart illustrations, and combinations of functional blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose, hardware-based computer systems which perform the specified functions or steps, or suitable combinations of special purpose hardware and computer instructions.

As used herein, the terms “user” and “participant” shall interchangeably refer to any person, entity, charitable organization, machine, hardware, software, or business who accesses and uses the system of the invention, including consumers, retailers, manufacturers, and third-party providers. Participants in the system may interact with one another either online or offline. As used herein, the term “online” refers to interactive communications that takes place between participants who are remotely located from one another, including communication through any of the networks or communications means described above or the like.

The term “manufacturer” shall include any person, entity, charitable organization, machine, software, hardware, and/or the like that manufactures, distributes, or originates a product or service which may ultimately be offered to a consumer directly or indirectly through a retailer. The term “manufacturer” may also include any party that generates and/or provides manufacturer item identifiers. The term “retailer” shall include any person, entity, charitable organization, machine, software, hardware, and/or the like that that offers a product or service to a consumer. As used herein, the term “retailer” is used interchangeably with the term “merchant”. Moreover, in this context, a retailer or merchant may offer or sell, either online or offline, products and/or services made or supplied by at least one manufacturer. As used herein, the phrases “network level” and “network-wide level” shall refer to a system that includes more than one retailer and at least one manufacturer.

As used herein, the terms “purchaser”, “customer”, “consumer”, and “end-user” may be used interchangeably with each other, and each shall mean any person, entity, charitable organization, or business which uses a consumer ID to participate in the present system. A “consumer ID”, as used herein, includes any device, code, or other identifier suitably configured to allow the consumer to interact or communicate with the system, such as, for example, a rewards card, charge card, credit card, debit card, prepaid card, telephone card, smart card, magnetic stripe card, bar code card, authorization/access code, personal identification number (PIN), Internet code, other identification code, and/or the like. Additionally, a “consumer ID” may comprise any form of electronic, magnetic, and/or optical device capable of transmitting or downloading data from itself to a second device which is capable of interacting and communicating with such forms of consumer ID.

Though the invention may generically be described with reference to a series of transactions which transfer a good or service from an originating party to an intermediary party and a subsequent transaction which transfers the good or service from the intermediary party to an end-user of that good or service, for convenience and purposes of brevity and consistency, the present disclosure generally refers to the originating party as a manufacturer, the intermediary party as a retailer, the end-user as a consumer, and a good or service as a product or item. However, it will be recognized by those of ordinary skill in the art that the retailer need not provide a product or item to a consumer in exchange for monetary currency. While this often may be the case, the present disclosure is not so limited and includes transactions which may be gratuitous in nature, whereby the retailer transfers a product or item to a consumer without the consumer providing any currency or other value in exchange. It is further noted that additional participants, referred to as third-party providers, may be involved in some phases of the transaction, though these participants are not shown. Exemplary third-party providers may include financial institutions, such as banks, credit card companies, card sponsoring companies, or issuers of credit who may be under contract with financial institutions. It will be appreciated that any number of consumers, retailers, manufacturers, third-party providers, and the like may participate in the system of the present invention.

As used herein, the term “UPC” and the phrase “manufacturer item identifier” shall refer to any symbol or indicia which provides information and, in an exemplary embodiment, shall refer to any number, code, or identifier assigned by a manufacturer and associated with an item, including any type of goods and/or services, ultimately offered to a consumer or other end-user. Colloquially, a UPC is sometimes referred to as a SKU number. However, as used herein, the term “SKU” and the phrase “retailer item identifier” shall refer to any symbol or indicia which provides additional information and, in an exemplary embodiment, shall refer to any number, code, or identifier assigned by a retailer and associated with an item, including any type of goods and/or services, offered to a consumer or other end-user.

“Purchase data”, as used herein, comprises data relating to the offer of any item to a consumer or other end-user. Purchase data may include any of the following: an item purchased, an item price, a number of items purchased, a total transaction price, a payment vehicle, a date, a store identifier, an employee identifier, a retailer item identifier, a loyalty identifier, and/or the like.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A point of sale (POS) device comprising:
means for identifying user selection actions on a POS device and based on the action changing the default color of a numpad to a different default color associated with a quick key for that action, and
means for simultaneously changing the default number, key, and symbol arrangements on the numpad to the default number, key and symbol arrangements of the quick key action.

2. The POS device of claim 1, wherein the quick key actions include at least one of a cash value discount selection key and a percent cash value selection key.

3. The POS device of claim 2, wherein at least one quick key action is triggered by performing a tactile gesture which in turn causes a trigger action to be displayed on the user interface screen in a particular color which color matches the numpad color, which numpad color is different from the default numpad color.

4. The POS device of claim 3, further comprising means for generating quick keys that identify the product or service charged to the customer, wherein when the quick key is triggered, the default indicators for that item includes a default number of purchase items, a price per purchase item, and the total cost of displayed default items.

5. The POS device of claim 4, further comprising means for detecting when a certain quick key is triggered and causing various functions to be enabled, including a function for manually changing the amount of purchase items, while at the same time changing the color, number, key and symbol arrangements on the numpad to match the default color of the quick key action, as well as the number, key and symbol arrangements associated with the same quick key action.

6. The POS device of claim 5, further comprising means for downloading a products list and the associated list of products for each product list from a central processing services provider.

7. The POS device of claim 1, wherein at least one quick key action is triggered by performing a tactile gesture which in turn causes a trigger action to be displayed on the user interface screen in a particular color which color matches the numpad color, which numpad color is different from the default numpad color.

8. The POS device of claim 1, further comprising means for generating quick keys that identify the product or service charged to the customer, wherein when the quick key is triggered, the default indicators for that item includes a default number of purchase items, a price per purchase item, and the total cost of displayed default items.

9. The POS device of claim 1, further comprising means for detecting when a certain quick key is triggered and causing various functions to be enabled, including a function for manually changing the amount of purchase items, while at the same time changing the color, number, key and symbol arrangements on the numpad to match the default color of the quick key action, as well as the number, key and symbol arrangements associated with the same quick key action.

10. The POS device of claim 1, further comprising means for downloading a products list and the associated list of products for each product list from a central processing services provider.

11. A method, implemented by a POS device, comprising:
identifying user selection actions on a POS device and based on the action changing the default color of a numpad to a different default color associated with a quick key for that action, and
simultaneously changing the default number, key, and symbol arrangements on the numpad to the default number, key and symbol arrangements of the quick key action.

12. The method of claim 11, wherein the quick key actions include at least one of a cash value discount selection key and a percent cash value selection key.

13. The method of claim 12, wherein at least one quick key action is triggered by performing a tactile gesture which in turn causes a trigger action to be displayed on the user interface screen in a particular color which color matches the numpad color, which numpad color is different from the default numpad color.

14. The method of claim 13, further comprising generating quick keys that identify the product or service charged to the customer, wherein when the quick key is triggered, the default indicators for that item includes a default number of purchase items, a price per purchase item, and the total cost of displayed default items.

15. The method of claim 14, further comprising detecting when a certain quick key is triggered and causing various functions to be enabled, including a function for manually changing the amount of purchase items, while at the same time changing the color, number, key and symbol arrangements on the numpad to match the default color of the quick key action, as well as the number, key and symbol arrangements associated with the same quick key action.

16. The method of claim 15, wherein the POS device downloads a products list and the associated list of products for each product list from a central processing services provider.

17. The method of claim 11, wherein at least one quick key action is triggered by performing a tactile gesture which in turn causes a trigger action to be displayed on the user interface screen in a particular color which color matches the numpad color, which numpad color is different from the default numpad color.

18. The method of claim 11, further comprising means for generating quick keys that identify the product or service charged to the customer, wherein when the quick key is triggered, the default indicators for that item includes a default number of purchase items, a price per purchase item, and the total cost of displayed default items.

19. The method of claim 11, further comprising means for detecting when a certain quick key is triggered and causing various functions to be enabled, including a function for manually changing the amount of purchase items, while at the same time changing the color, number, key and symbol arrangements on the numpad to match the default color of the quick key action, as well as the number, key and symbol arrangements associated with the same quick key action.

20. The method of claim 11, wherein the POS device downloads a products list and the associated list of products for each product list from a central processing services provider.
